(19) United States
(12) Patent Application Publication
(10) Pub. No.: US 2016/0284127 A1
(43) Pub. Date: Sep. 29, 2016

(54) INDIVIDUALIZED CONTENT IN AUGMENTED REALITY SYSTEMS

(71) Applicant: International Business Machines Corporation, Armonk, NY (US)

(72) Inventors: Sarbajit K. Rakshit, Kolkata (IN); John D. Wilson, Houston, TX (US)

(21) Appl. No.: 14/669,558

(22) Filed: Mar. 26, 2015

(51) Int. Cl. G06T 19/00

(52) U.S. Cl. CPC G06T 19/006

(57) ABSTRACT

A method for distributing individualized content in an augmented reality system is provided. An occurrence of a trigger even is registered wherein the trigger event is associated with an annotation of an audiovisual presentation. The annotation is sent to an augmented reality device that is associated with a key, wherein the augmented reality device is associated with the key based, at least in part, on one or more attributes of a viewer profile that is associated with the augmented reality device.

### BACKGROUND OF THE INVENTION

The present invention relates generally to the field of augmented reality systems, and more particularly to delivering individualized content in augmented reality systems.

An augmented reality system is a computing system that provides a user with supplemental information concerning, for example, people, places, and objects in the vicinity of the user. In general, augmented reality systems present supplemental information in conjunction with an image or real-world view of the surrounding environment. In some augmented reality systems, a display presents a computer generated image that merges supplemental information and a computer generated image of the surrounding environment. In other augmented reality systems, supplemental information is presented on a transparent display, or projected onto a transparent medium, such that the supplemental information is an overlay on a real-world view of the surrounding environment. Depending on the computing capabilities of a particular augmented reality system, the supplemental information can include text, images, video, and/or audio. In general, supplemental information is presented to the user based, at least in part, on data collected by one or more sensors. Augmented reality systems can include, for example, image sensors, GPS sensors, laser range finders, accelerometers, gyroscopes, compasses, and/or radio-frequency receivers. These sensors can provide an augmented reality system with information concerning the geographic location of a user, the line of sight of a user, and/or the proximity of a user to a particular place, person, or object.

### SUMMARY

According to one embodiment of the present disclosure, a method for distributing individualized content in augmented reality systems is provided. The method includes registering, by one or more computer processors, an occurrence of a trigger event, wherein the trigger event is associated with an annotation of an audiovisual presentation; and sending, by one or more computer processors, the annotation to an augmented reality device that is associated with a key, wherein the augmented reality device is associated with the key based, at least in part, on one or more attributes of a viewer profile that is associated with the augmented reality device.

According to another embodiment of the present disclosure, a computer program product for distributing individualized content in augmented reality systems is provided. The computer program product comprises a computer readable storage medium and program instructions stored on the computer readable storage medium. The program instructions include program instructions to register an occurrence of a trigger event, wherein the trigger event is associated with an annotation of an audiovisual presentation; and program instructions to send the annotation to an augmented reality device that is associated with a key, wherein the augmented reality device is associated with the key based, at least in part, on one or more attributes of a viewer profile that is associated with the augmented reality device.

According to another embodiment of the present disclosure, a computer system distributing individualized content in augmented reality systems is provided. The computer system includes one or more computer processors, one or more computer readable storage media, and program instructions stored on the computer readable storage media for execution by at least one of the one or more processors. The program instructions include program instructions to register an occurrence of a trigger event, wherein the trigger event is associated with an annotation of an audiovisual presentation; and program instructions to send the annotation to an augmented reality device that is associated with a key, wherein the augmented reality device is associated with the key based, at least in part, on one or more attributes of a viewer profile that is associated with the augmented reality device.

### BRIEF DESCRIPTION OF THE DRAWINGS

FIG. 1 is a functional block diagram illustrating a computing environment, in accordance with an embodiment of the present disclosure.

FIG. 2 is a flowchart that depicts operations for distributing annotations to augmented reality devices within the computing environment of FIG. 1, in accordance with an embodiment of the present disclosure.

FIG. 3A is a table that depicts an example of an annotations database within the computing environment of FIG. 1, in accordance with an embodiment of the present disclosure.

FIG. 3B is a functional block diagram that depicts an example of an augmented reality presentation system that sends annotations to an augmented reality device based, at least in part, on a gaze point of a user of the augmented reality device, in accordance with an embodiment of the present disclosure.

FIG. 4 is a flowchart that depicts operation for distributing annotations to an augmented reality device based, at least in part, on a gaze point of a user of the augmented reality device, in accordance with an embodiment of the present disclosure.

FIG. 5A is a table that depicts an example of a comment database within the computing environment of FIG. 1, in accordance with an embodiment of the present disclosure.

FIG. 5B is a functional block diagram that depicts an example of an augmented reality presentation system that sends comments to one or more augmented reality devices, in accordance with an embodiment of the present disclosure.

FIG. 6 is a flowchart that depicts operations for distributing comments to one or more augmented reality devices, in accordance with an embodiment of the present disclosure.

FIG. 7 depicts a computer system that is representative of one or more computing devices within the computing environment of FIG. 1, in accordance with an embodiment of the present disclosure.

### DETAILED DESCRIPTION

An embodiment of the present invention recognizes a need to distribute individualized augmented reality content to augmented reality devices based on one or more attributes of respective users of the augment reality devices.

Audio-visual presentations (e.g., slide-based presentations) are one example of a situation in which an augmented reality system can provide useful supplemental information. Computer-generated slides generally do not include detailed explanations of their contents. Instead, computer-generated slides often contain bullet points, which a presenter verbally elaborates on in front of the audience. The presenter, however, cannot tailor the verbally communicated information for specific individuals or specific classes of individuals without separately addressing the different individuals and/or different classes of individuals. Moreover, information security concerns generally prevent distribution of sensitive information if some members of the audience are not authorized to receive the sensitive information.

Embodiments of the present disclosure provide a system and a method to distribute individualized augmented reality content. In some embodiments, an audio-visual presentation includes base content and one or more annotations for distribution to particular viewers and/or particular classes of viewers via one or more augmented reality devices. Each annotations is distributed to one or more viewers based, at least in part, on one or more attributes of the respective viewer(s). One or more augmented reality devices receive and display the annotation(s).

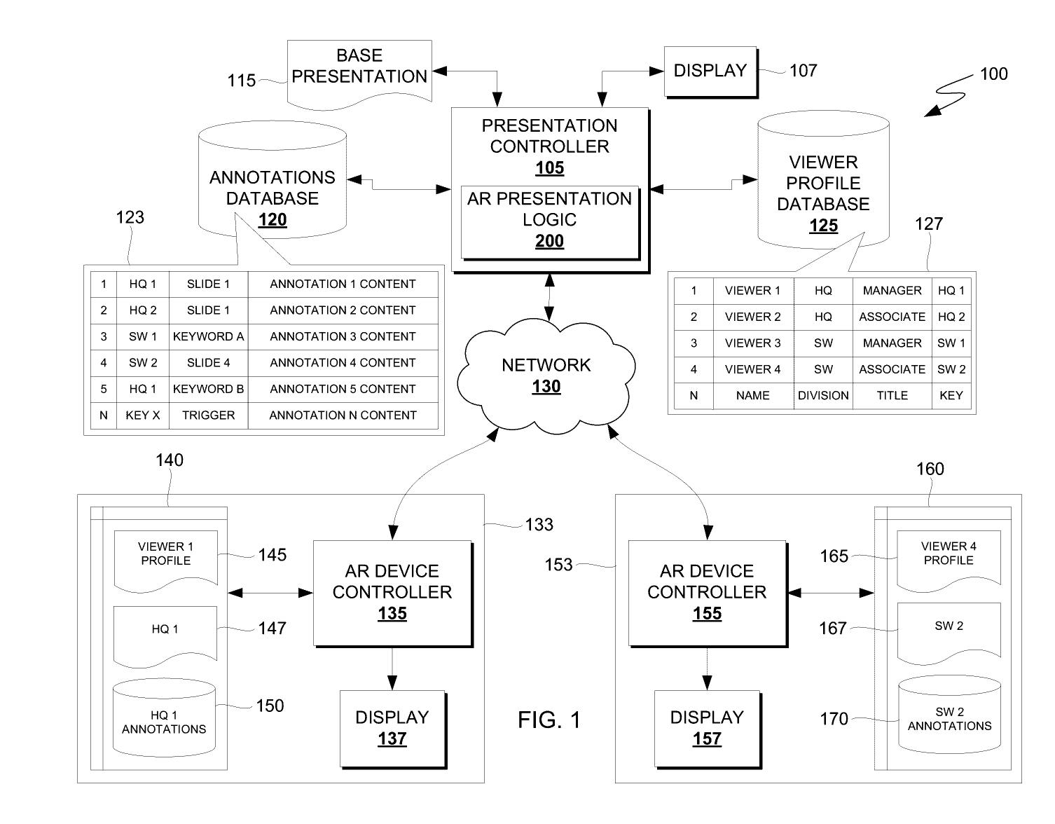

The present disclosure will now be described in detail with reference to the Figures. FIG. 1 is a functional block diagram illustrating augmented reality presentation system 100, in accordance with an example of an embodiment of the present disclosure. Augmented reality presentation system 100 (AR presentation system 100) includes presentation controller 105, augmented reality device 133 (AR device 133), and augmented reality device 153 (AR device 153). In some embodiments, at least one of AR device 133 and AR device 153 is a wearable augmented reality devices (e.g., eyeglasses, goggles, and contact lenses). In other embodiments, at least one of AR device 133 and AR device 153 is a system of computing devices, wherein the system includes a wearable augmented reality device and at least one other computing device (e.g., a smartphone, a tablet computer, or a laptop computer) interconnected over a network (e.g., network 130). In yet other embodiments, at least one of AR device 133 and AR device 153 is not an augmented reality device, but supports functionality sufficient to perform the functionality attributed herein to one or both of AR device 133 and AR device 153 (e.g., a device that can display comments in supplemental information fields as described herein). AR device 133 and AR device 153 respectively include augmented reality device controller 135 (AR device controller 135) and augmented reality device controller 155 (AR device controller 155), wherein AR device controllers 135 and 155 have similar functionality as described herein. FIG. 1 depicts an example of an embodiment having two augmented reality devices for illustrative simplicity. Other examples include a greater number of augmented reality devices.

Network 130 interconnects presentation controller 105, AR device 133, and AR device 153. AR device controllers 135 and 155 are capable of communicating with, among other things, presentation controller 105 over network 130. In various embodiments, network 130 is a local area network (LAN), a wide area network (WAN) such as the Internet, or a combination of the two, and may include wired and/or wireless interfaces. In general, network 130 is any combination of connections and protocols that support communications between presentation controller 105, AR device controller 135, and AR device controller 155, in accordance with an embodiment of the present invention.

Presentation controller 105 is a computing device that executes augmented reality presentation logic 200 (AR presentation logic 200), as described herein. In various embodiments, presentation controller 105 is (or is integrated into) a standalone device, a server, a laptop computer, a tablet computer, a netbook computer, a personal computer (PC), or a desktop computer. In another embodiment, presentation controller 105 represents a computing system utilizing clustered computers and components to act as a single pool of seamless resources. In general, presentation controller 105 is any computing device or combination of devices with access to some or all of base presentation 115, annotations database 120, viewer profile database 125, AR device controller 135, and AR device controller 155, and with access to and/or capable of executing augmented reality presentation logic 200, as described herein.

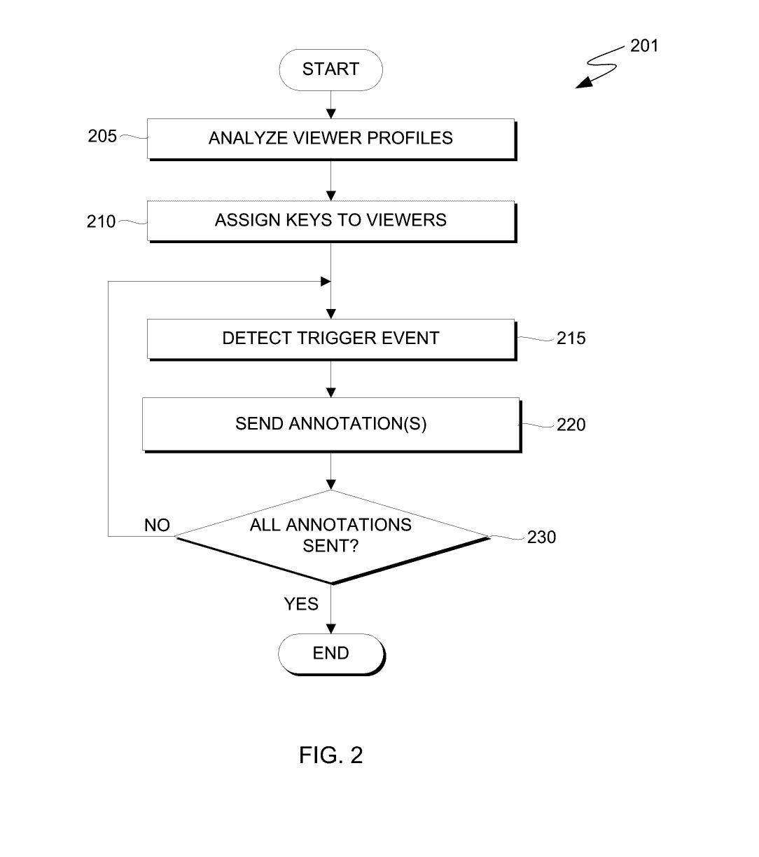

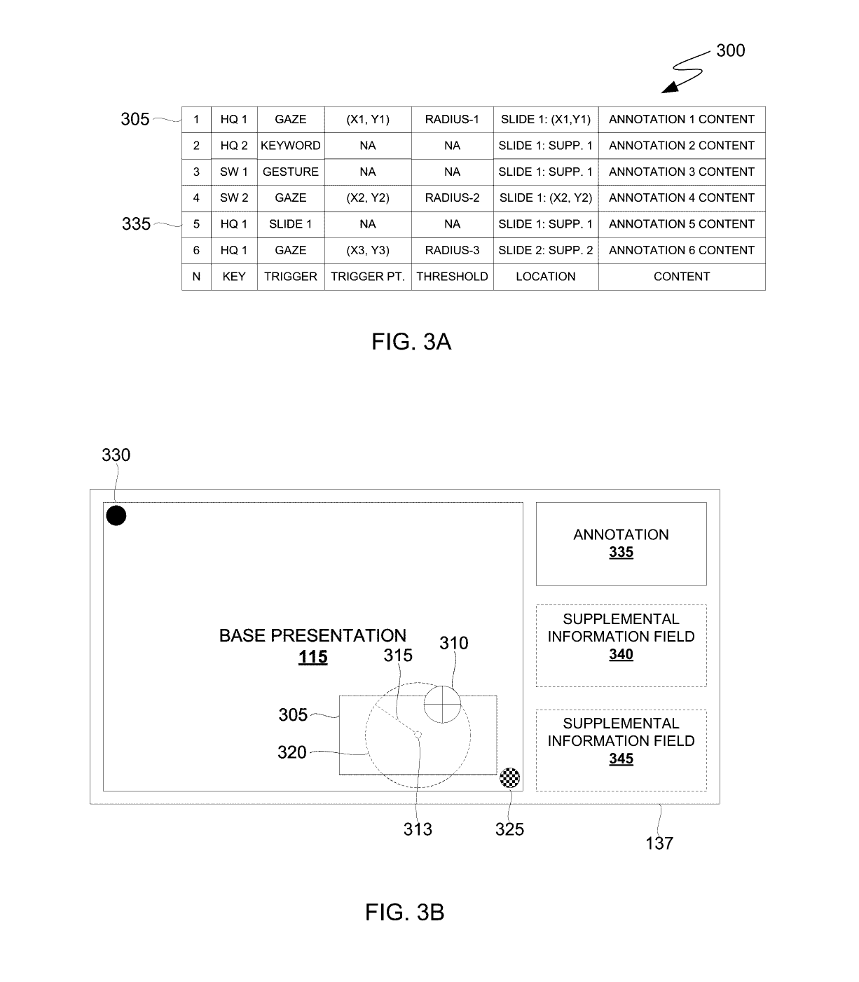

In various embodiments, base presentation 115 is data that describes video, images, sounds, and/or text that form the basis for an audiovisual presentation (e.g., slides in an audio-visual presentation). Annotations database 120 is a database that includes data that describes video, images, sounds, and/or text that supplements base presentation 115. Annotations database 120 includes information for distribution to one or more specifically identified viewers or classes of viewers. Table 123 is an example data structure of annotations database 120, wherein each row identifies a different annotation, and the columns respectively identify a number, at least one key, a trigger event, and content that is associated with each annotation. In the embodiment depicted in FIG. 1, each annotation is associated with one key. In other embodiments, some annotations are associated with a plurality of keys. A trigger event is an event that causes presentation controller 105 to send one or more annotations to respective AR device controllers. In the embodiment depicted in FIG. 1, for example, displaying a particular slide of base presentation 115 triggers annotations in the first, second, and fourth rows of table 123, whereas speaking keyword(s) triggers annotations in the third and fourth rows of table 123. Trigger events are discussed in greater detail with respect to FIGS. 2, 3A, and 3B.

Presentation controller 105 reads from and writes to viewer profile database 125 in the embodiment depicted in FIG. 1. Viewer profile database 125 is written to and/or read by some or all of presentation controller 105, AR device controller 135, and AR device controller 155 in various embodiments. Table 127 is an example data structure of viewer profile database 125, wherein each row identifies a viewer, and the columns respectively identify viewer names, business division names, job titles, and keys. In some embodiments, augmented reality presentation logic 200 populates the key column by assigning keys to each viewer based, at least in part, on viewer profiles that include one or more attributes of the respective viewers. In FIG. 1, for example, each viewer is assigned a key based on his or her division and job title. There is one set of keys for headquarters (HQ) employees and another set of keys for software group [SW] employees. Within each set of keys, there is a key for managers and a different key for associates. Viewer profile database 125 can store any data from which AR presentation logic 200 can assign keys to viewers, as described in greater detail with respect to FIG. 2. In other embodiments, viewer profile database 125 is populated with viewer profiles that include pre-assigned keys, wherein it is unnecessary for augmented reality presentation logic 200 to populate the key column. In general, viewer profile database 125 stores data in a data structure that enables presentation controller 105 to distribute annotations to appropriate viewers based on one or more attributes of the viewers.

Presentation controller 105 accesses base presentation 115, annotations database 120, and viewer profile database 125 on one or more computer storage devices. In some embodiments, one or more of base presentation 115, annotations database 120, and viewer profile database 125 are stored locally on one or more internal storage devices including one or more magnetic hard disk drives, solid state hard drives, semiconductor storage devices, read-only memory (ROM), erasable programmable read-only memory (EPROM), flash memory, or another computer-readable storage medium. In other embodiments, one or more of base presentation 115, annotations database 120, and viewer profile database 125 reside on another computer storage device or combination of devices, provided that each is accessible by presentation controller 105. In yet other embodiments, one or more of base presentation 115, annotations database 120, and viewer profile database 125 reside on an external computer storage device or combination of devices and are accessed through a communication network, such as network 130.

Augmented reality presentation system 100 includes display 107. Display 107 is an electronic device that presents base presentation 115 to one or more viewers (i.e., users of AR devices 133 and 153). Accordingly, presentation controller 105 transmits data to display 107. A data cable (not shown) electrically connects presentation controller 105 and display 107 in the embodiment depicted in FIG. 1. In other embodiments, presentation controller 105 transmits data to display 107 over a network, such as network 130. In some embodiments, display 107 is a television or computer screen that presents at least a portion of base presentation 115. In other embodiments, display 107 is a projector that projects at least a portion of base presentation 115 onto a screen. If base presentation 115 includes one or more audio elements, augmented reality presentation system 100 includes one or more speakers for transmitting the audio elements.

FIG. 1 depicts an example of an embodiment wherein the user of AR devices 133 is “Viewer 1” and the user of AR device 153 is “Viewer 4,” as shown in table 127. In this example, AR device controller 135 and 155 respectively transmit the Viewer 1 profile and the Viewer 4 profile over network 130 to populate, at least in part, viewer profile database 125. Accordingly, AR device controllers 135 and 155 respectively receive HQ 1 annotations and SW 2 annotations from presentation controller 105. In some embodiments, AR device controllers 135 and 155 store data locally. In the embodiment depicted in FIG. 1, AR device 133 includes internal storage device 140 that stores, for example, profile 145 (the Viewer 1 profile), key 147 (the HQ 1 key), and HQ 1 annotations 150 (a database of HQ 1 annotations). Similarly, AR device 153 includes internal storage device 160 that stores, for example, profile 165 (the Viewer 4 profile), key 167 (the SW 2 key), and SW 2 annotations 170 (a database of SW 2 annotations). In various embodiments, internal storage devices 140 and 160 are each a magnetic hard disk drive, a solid state hard drive, a semiconductor storage device, read-only memory (ROM), erasable programmable read-only memory (EPROM), flash memory, or another computer-readable storage medium that is capable of storing digital information. In other embodiments, AR device controllers 135 and/or 155 read from and/or write to an external computer storage device (e.g., internal storage device 140 or internal storage device 160) over a personal area network or another network, such as network 130.

AR devices 133 and 153 respectively include display 137 and display 157. In one example of the embodiment depicted in FIG. 1, at least one of displays 137 and 157 is a transparent OLED display, an optical wave guide, a wave splitter, or another substantially transparent device that presents augmented reality content as an overlay on a real-world view of the surrounding environment. In other examples, at least one of displays 137 and 157 is an opaque electronic display that presents a computer image of the surrounding environment, wherein the image of the surrounding environment is merged with augmented reality content.

FIG. 2 is a flowchart depicting operations 201 of AR presentation logic 200, wherein AR presentation logic 200 assigns one or more keys to a plurality of viewers, in accordance with an embodiment of the present disclosure. In some embodiments, presentation controller 105 executes AR presentation logic 200. In other embodiments, another computing device or combination of computing devices executes AR presentation logic 200.

In operation 205, AR presentation logic 200 analyzes viewer profiles within, for example, viewer profile database 125. In general, however, AR presentation logic 200 can analyze viewer profiles located in any repository of data to which it has access. The analysis performed in operation 205 includes operations to determine one or more attributes of each viewer profile in viewer profile database 125. When executed on presentation controller 105 within the example of augmented reality presentation system 100 depicted in FIG. 1, AR presentation logic 200 determines the divisions to which each viewer belongs and the job title of each viewer in operation 205. The analysis performed in operation 205 is based, at least in part, on the rules by which AR presentation logic 200 assigns keys to viewers as described with respect to operation 210.

In operation 210, AR presentation logic 200 assigns one or more keys to the viewers based, at least in part, on the analysis performed in operation 205. When executed on presentation controller 105 within the example augmented reality presentation system 100 depicted in FIG. 1, AR presentation logic 200 assigns one of the HQ 1, HQ 2, SW 1, and SW 2 keys to each viewer based on the data in table 127. By way of example, AR presentation logic 200 determines that Viewer 1 is a headquarters division manager in operation 205. In operation 210, AR presentation logic 200 assigns Viewer 1 the HQ 1 key, wherein the HQ 1 key is assigned to headquarters division managers in the embodiment depicted in FIG. 1. In other embodiments keys are assigned based, at least in part, on other attributes, such as security clearances, education, and/or various other qualifications and/or factors. AR presentation logic 200 implements rules that include the aforementioned attributes as variables. In some embodiments, variables are weighted and some variables are weighted more than others. Persons of ordinary skill in the art will understand that AR presentation logic 200 can implement rules of varying complexity to assign one or more keys to viewers based on respective viewer profiles.

In operation 215, AR presentation logic 200 detects and registers a trigger event. A trigger event is an event that is associated with one or more annotations and causes AR presentation logic 200 to send the annotation(s) to one or more AR device controllers, such as AR device controllers 135 and 155. In the embodiment depicted in FIG. 1, for example, displaying the first slide of base presentation 115 is a trigger event for annotations in the first and second rows of table 123, and displaying the fourth slide is a trigger event for the annotation in the fourth row of table 123. Speaking respective keywords, however, triggers annotations in the third and fifth rows of table 123. In other examples, a combination of events triggers some annotations (e.g., speaking one or more keywords while presenting a specific slide). Yet another example of a trigger event is performing a particular gesture, such as pointing to a portion of a slide or holding a particular object. Various embodiments of the present disclosure include one or more input devices, voice recognition hardware and software, and/or gesture recognition hardware and software to detect and register the aforementioned trigger events.

In operation 220, AR presentation logic 200 causes presentation controller 105 to send one or more annotations to one or more AR device controllers (e.g., AR device controllers 135 and/or 155). In some embodiments, viewer profile database 125 includes network addresses (e.g., IP and/or MAC addresses) that enable electronic communication with one or more AR device controllers over a network, such as network 130. In other words, AR presentation logic 200 associates each viewer with a network address in such embodiments. By way of example, AR presentation logic 200 associates Viewer 1 with the MAC address of AR device controller 135 (not shown) and Viewer 4 with the MAC address of AR device controller 155 (not shown) in the embodiment depicted in FIG. 1. In general, AR presentation logic 200 supports one or more communication protocols that enable transmission of augmented reality content, such as annotations, to AR device controllers.

Some embodiments of the present disclosure support one or more security protocols to provide information security during electronic communications between various computing devices. In one example, AR presentation logic 200 supports public key infrastructure for communications between presentation controller 105 and various AR device controllers, such as AR device controller 135 and 155. In another example, AR presentation logic 200 utilizes digital signatures for communication between the aforementioned devices. In some embodiments, the security protocols are based, at least in part, on the keys associated with the annotations. In the embodiment in FIG. 1, for example, AR device controller 135 reads and sends key 147 (an HQ 1 key) as part of a security protocol. One aspect of the security protocol includes an interrogation step, wherein AR presentation logic 200 interrogates AR device controller 135 for the HQ 1 key. AR presentation logic 200 verifies that AR device controller 135 is permitted to receive HQ 1 annotations based, at least in part, on receiving a valid HQ 1 key from AR device controller 135. Similarly, AR device controller 155 reads and sends key 167 (an SW 2 key) as part of the security protocol, wherein AR presentation logic 200 verifies that AR device controller 155 is permitted to receive SW 2 annotations.

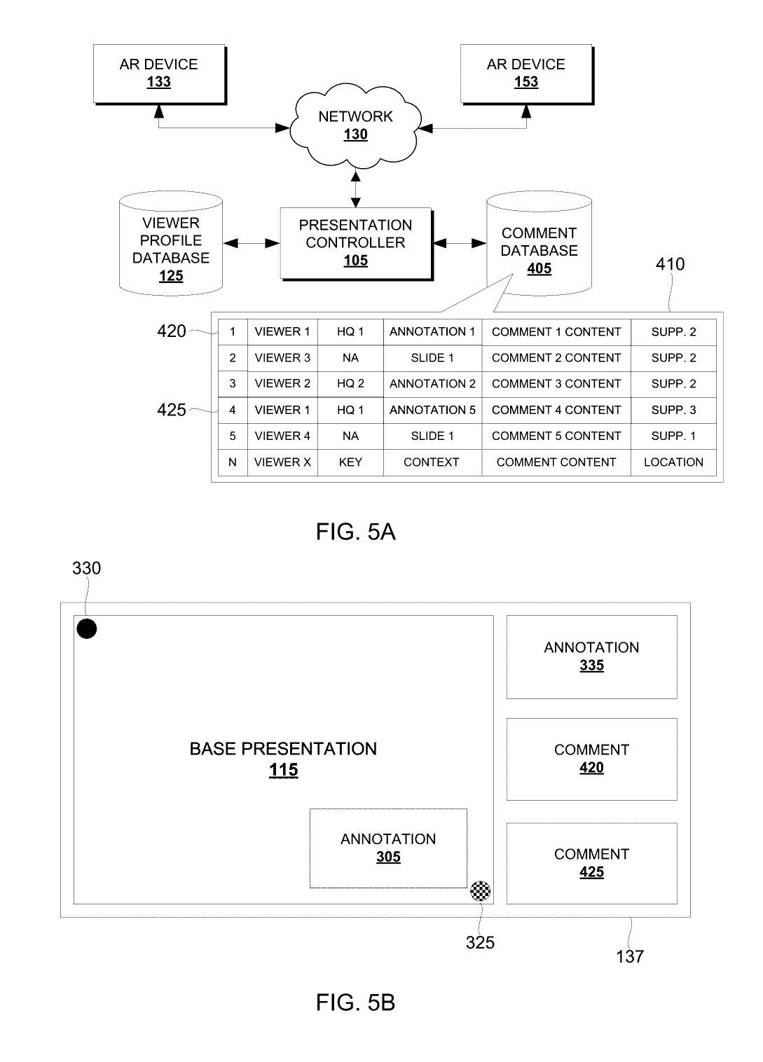

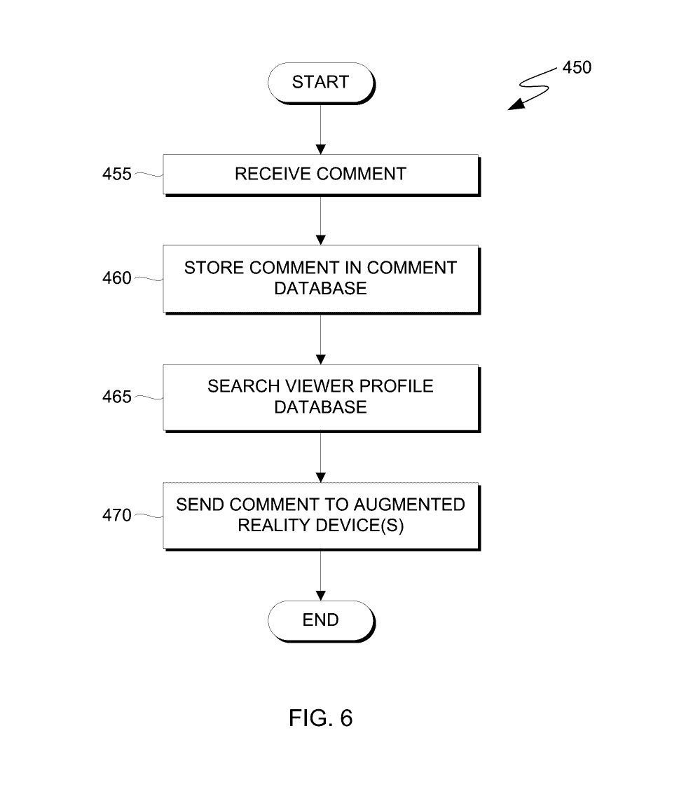

In decision 230, AR presentation logic 200 determines whether or not presentation controller 105 sent all annotation content within, for example, annotations database 120. If AR presentation logic 200 determines that presentation controller 105 sent all annotation content within annotations database 120 (decision 230, YES branch), AR presentation logic 200 terminates, at least to the extent depicted in FIG. 2. In some embodiments, AR presentation logic 200 has additional functionality that does not terminate when presentation controller 105 sends all annotation content within annotations database 120 (e.g., the comment system depicted in FIGS. 5A, 5B, and 6). If AR presentation logic 200 determines that presentation controller 105 did not send all annotation content within annotations database 120 (decision 230, NO branch), AR presentation logic 200 performs one or more iterations of operation 215, operation 220, and decision 230.

FIGS. 3A and 3B depict one example of an embodiment of augmented reality presentation system 100 that includes annotations that are presented as overlay on base presentation content. Other annotations are presented in supplemental information fields that do not overlay base presentation content. The annotations are presented on a display of a head-mounted augmented reality device, in accordance with an embodiment of the present disclosure.

FIG. 3A depicts table 300, which is an example of a data structure of annotations database 120. Each row in the table is associated with an annotation. Table 300 includes columns that respectively associate a number, a key, a trigger event, coordinates of a trigger point (if applicable), a threshold for presenting the annotation (if applicable), and content with a respective annotation. The first row of table 300 describes annotation 305. The fifth row of table 300 describes annotation 335. Annotations 305 and 335 are discussed in greater detail with respect to FIG. 3B.

FIG. 3B is a functional block diagram that depicts an example of an augmented reality presentation as viewed on an augmented reality device, wherein the augmented reality device presents two of the annotations described in FIG. 3A, in accordance with an embodiment of the present disclosure. In the example depicted in FIG. 3B, Viewer 1 of table 127 is the user of AR device 133 (referred to as “Viewer 1” hereafter). In this example, AR device 133 is a head-mounted augmented reality device (e.g., a pair of augmented reality eyeglasses), and display 137 is a transparent electronic display (e.g., a transparent OLED display). In FIG. 3B, display 107 presents “Slide 1” of base presentation 115. A portion of Slide 1 is visible through inactive portion(s) of display 137, which presents visual representations of annotations 305 and 335.

Some embodiments of the present disclosure include augmented reality devices (e.g., AR devices 133 and 153) that have the ability to determine the gaze point of respective users. In one example of such embodiments, AR device 133 has the ability to determine a gaze point based, at least in part, on eye-in-head angles of one or both of the eyes of Viewer 1. In various embodiments, AR device 133 determines the rotational position of one or both eyes of the Viewer 1 via: a sensor that determines the rotational position of an object that is connected to an eye of Viewer 1 (e.g., a contact lens having an embedded mirror or magnet); one or more video cameras that optically track the cornea, the lens, one or more blood vessels, and/or other feature of one or both eyes of Viewer 1; or another technique for determining eye-in-head angles of one or both eyes of Viewer 1. In various embodiments, AR device 133 also has the ability to determine the orientation and direction(s) of movement of AR device 133 in relation to the ground via a plurality of microelectromechanical systems (MEMS). In one example of such embodiments, AR device 133 includes one or more MEMS gyroscopes that enable AR device 133 to determine the orientation of AR device 133 with respect to the gravitational field of the Earth. In another example of such embodiments, AR device 133 also includes a plurality of MEMS accelerometers to measure movements of AR device 133 in six degrees of freedom. In addition, various embodiments of the present disclosure also have the ability to determine the position and orientation of AR device 133 relative to display 107 (e.g., via on more video cameras and scale bar(s)). Person of ordinary skill in the art will understand that such embodiments of AR device 133, and other augmented reality devices having the aforementioned abilities, are able to determine the location of the gaze point of the user within the surrounding environment (e.g. AR devices 133 and 153 are able to determine the location of the gaze points of respective users on display 107).

In some embodiments of the present disclosure, the gaze point of a viewer triggers one or more annotations. In one embodiment, one or more annotations are presented when the distance between a gaze point and a trigger point is less than a threshold distance. In one example of such an embodiment, the trigger point is a point that is located within a visual representation of an annotation (e.g., the centroid of a rectangular text box) that overlays base presentation content (e.g., a slide of base presentation 115). In another example of such an embodiment, the trigger point is a point on a visual representation of base presentation content, wherein a visual representation of an associated annotation does not overlay the base presentation content.

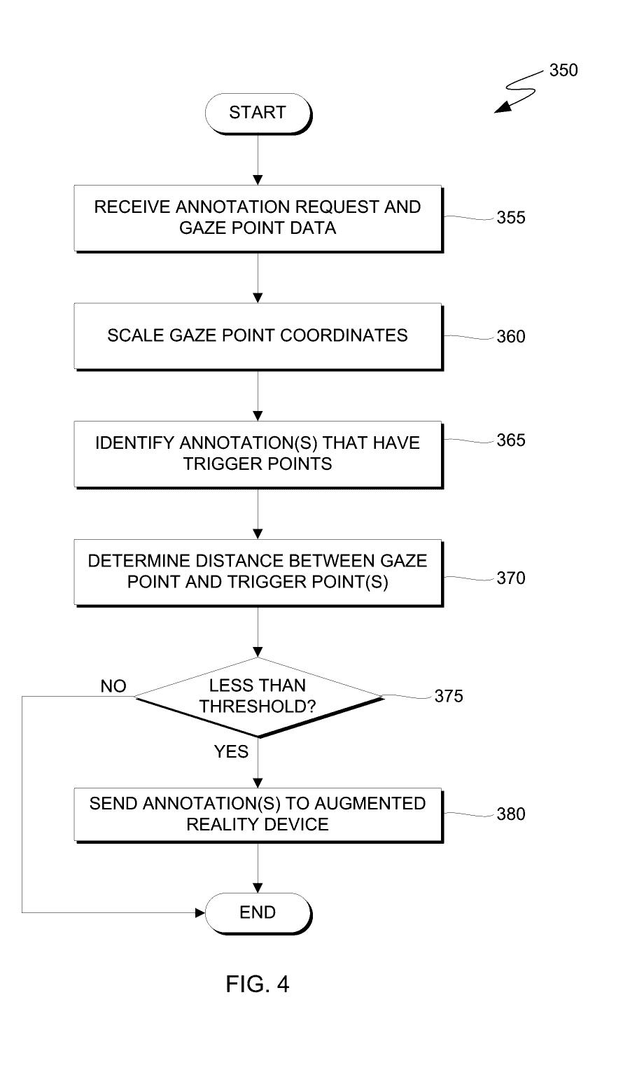

In the example depicted in FIG. 3B, gaze point 310 of Viewer 1 triggers annotation 305 when the distance between gaze point 310 and the trigger point of annotation 305 is less than threshold distance 315. The trigger point of annotation 305 is centroid 313, which is the centroid of the visual representation of annotation 305. Centroid 313 has coordinates (X1, Y1), as shown in FIG. 3A (i.e., the location of annotation 305 is defined, at least in part, by the coordinates of centroid 313). Threshold distance 315 is measured from centroid 313 in this example (i.e., threshold distance 315 is a radius in this example, as shown in FIG. 3A). Accordingly, threshold distance 315 defines threshold boundary 320, wherein threshold boundary 320 is the perimeter of a circle that is centered on centroid 313 and has a radius that is equal to threshold distance 315. If gaze point 310 is between centroid 313 and threshold boundary 320 (i.e., the distance between gaze point 310 and centroid 313 is less than threshold distance 315), display 137 presents, among other things, annotation 305. In the example depicted in FIG. 3B, gaze point 310 is represented as a circle that is bisected by a horizontal and a vertical line, wherein the coordinates of gaze point 310 are the coordinates of the intersection of the horizontal and the vertical lines. FIG. 3B also includes registration point 325 and registration point 330. Registration points 325 and 330 are elements of base presentation 115 in the example depicted in FIG. 3B (i.e., display 107, as opposed to display 137, presents registration points 325 and 330). Distances and coordinates are determined with respect to a coordinate system that is defined, at least in part, by registration points 325 and 330, as discussed herein with respect to FIG. 4.

In the embodiment depicted in FIGS. 3A and 3B, annotations are also presented in supplemental information fields. In FIG. 3A, for example, annotation 335 is triggered by displaying Slide 1 and is presented in “SUPP. 1” in conjunction with Slide 1 (i.e., a first supplemental information field). In FIG. 3B, display 137 presents annotation 335, in accordance with FIG. 3A. Unlike annotation 305, annotation 335 is associated with a supplemental information field. In general, a supplemental information filed is an information field for that is capable of presenting visual information such that the visual information does not overlay a real-world view or computer image of base presentation content (e.g., base presentation 115). In FIG. 3B, for example, AR device 133 presents annotation 335 in a supplemental information field that is adjacent to the real-world view of base presentation 115 through display 137 (e.g., a transparent OLED display). FIG. 3B also depicts supplemental information field 340 and supplemental information field 345. In the example depicted if FIGS. 3A and 3B, no annotations are associated with Slide 1 and supplemental information fields 340 and 345. Accordingly, display 137 does not present annotations within supplemental information fields 340 and 345 in this example. In other examples, however, display 137 presents annotation(s) in one or both of supplemental information fields 340 and 345.

In some embodiments viewers (e.g., Viewer 1 and/or Viewer 4) are able to select how annotations are displayed on their respective AR devices (e.g., AR device 133 and 153). In one example of such embodiments, viewer profiles (e.g., viewer profile database 125) includes data that describes preferences of respective viewers. One example of a preference is whether or not a specific viewer wishes to receive all or only some annotations. Another example of a preference is how the specific viewer wishes comments to be displayed (e.g., a preference that all annotations are displayed in supplemental information fields). In another example of such embodiments, viewers select preferences on their respective AR devices.

In some embodiments of the present disclosure, augmented reality presentation system 100 includes computing devices that receive annotations from presentation controller 105, yet neither present a computer image of base presentation 115 nor enable a user to view base presentation 115 through a substantially transparent display. These computing devices, however, are capable of receiving and presenting annotations that are associated with supplemental information fields. In one example, AR device 133 (e.g., augmented reality eyeglasses) presents annotation 305 and a second computing device (e.g., a smartphone, a tablet computer, or a laptop computer) presents annotation 335 and/or another annotation associated with a supplemental information field. In another example, AR device 133 presents annotation 305 and a first instance of annotation 335, and the second computing device presents a second instance of annotation 335.

FIG. 4 is a flowchart that depicts operations 350 of AR presentation logic 200 on presentation controller 105 within augmented reality presentation system 100, wherein a gaze point triggers one or more annotations of annotations database 120, in accordance with an embodiment of the present disclosure.

In operation 355, presentation controller 105 receives an annotation request and gaze point data from an augmented reality device (e.g., AR device 133 as discussed with respect to FIGS. 3A and 3B). In some embodiments the annotation request includes a request for annotations and the key that is associated with the user of the augment reality device (e.g., the HQ 1 key that is associated with Viewer 1 in the example depicted in FIGS. 3A and 3B). In the embodiment depicted in FIG. 4, the gaze point data includes the coordinates of the gaze point, as determined by the augmented reality device. In some embodiments, the gaze point data also includes data concerning the coordinate system that the augmented reality device used to determine the coordinates of the gaze point. In one example of such an embodiment, the augmented reality device determines the coordinates of the gaze point with respect to a Cartesian coordinate system that is defined, at least in part, by a plurality of registration points (e.g., registration points 325 and 330) and a unit of length. In FIG. 3B, for example, registration points 325 and 330 are the endpoints of perpendicular line segments that respectively define the x-axis and the y-axis. In the embodiment depicted in FIG. 3B, the gaze point data includes the coordinates of gaze point 310 and the coordinates of registration points 325 and 330.

In operation 360, AR presentation logic 200 scales the gaze point coordinates relative to a reference coordinate system. In some embodiments, trigger points and other elements of base presentation 115 have coordinates that are defined by the reference coordinate system (i.e., reference system coordinates). In one example of such an embodiment, the reference coordinate system is a Cartesian coordinate system that is defined, at least in part, by a unit of length (i.e., the coordinates of a point are given in terms of a multiple of the unit of length along respective axes). Persons of ordinary skill in the art will understand that the coordinates of the gaze point can be determined using a non-reference Cartesian coordinate system having a different unit of length (i.e., non-reference system coordinates). Persons of ordinary skill in the art will also understand that a scale factor relates the reference system coordinates and the non-reference system coordinates. In some embodiments, AR presentation logic 200 determines a scaling factor in order to convert gaze point coordinates from non-reference system coordinates to reference system coordinates. In one example of such an embodiment, the scale factor is based, at least in part, on one or more registration points (e.g., registration points 325 and 330). In the embodiment depicted in FIG. 3B, for example, registration points 325 and 330 are elements of base presentation 115 and have reference system coordinates as a result. If the gaze point data includes non-reference system coordinates for registration points 325 and 330, AR presentation logic 200 compares the reference system coordinates and non-reference system coordinates of one or both of registration points 325 and 330 to determine the scaling factor. In such embodiments, AR presentation logic 200 uses the scaling factor to convert non-reference system gaze point coordinates to reference system gaze point coordinates. In other embodiments, however, operation 360 is unnecessary if presentation controller 105 receives gaze point data that includes reference system coordinates for the gaze point. In one example of such an embodiment, presentation controller 105 communicates data that describes the reference coordinate system to one or more augmented reality devices, wherein the augmented reality device(s) use the same unit of length as the reference coordinate system to determine the coordinates of the gaze point. In another example of such an embodiment, base presentation 115 includes data that describes the reference coordinate system (e.g., a scale bar or the coordinates of the registration points), wherein the augmented reality device(s) use the same unit of length as the reference coordinate system to determine the coordinates of the gaze point.

In operation 365, AR presentation logic 200 identifies one or more annotations that have a trigger point. In some embodiments, AR presentation logic 365 searches annotations database 120 for annotations that are associated with trigger points. In one example of such embodiments, AR presentation logic 200 searches annotation database 120 for annotations that are associated with one of a plurality of keys (e.g., the HQ 1 key) and searches among such annotations (e.g., annotations 305 and 335) for annotations that are associated with trigger points (e.g., annotation 305).

In operation 370, AR presentation logic 200 determines the distance between the gaze point and a trigger point (e.g., centroid 313) of one or more annotation. AR presentation logic 200 executes operation 370 for the trigger point of each annotation identified in operation 365. To determine the distance between the gaze point and a trigger point, AR presentation logic 200 uses reference system coordinates for the gaze point and the trigger point.

In decision 375. AR presentation logic 200 determines if the distance(s) determined in operation 370 are less than a threshold distance (e.g., threshold distance 315). If one or more of the distances determined in operation 370 are less than the threshold distance (decision 375, YES branch), AR presentation logic 200 executes operation 380. If none of the distances determined in operation 370 are less than the threshold distance (decision 375, NO branch), operations 350 end.

In operation 380, AR presentation logic causes presentation controller 105 to send one or more annotation to the augmented reality device from which presentation controller 105 received the request for annotations in operation 355.

FIGS. 5A and 5B depict one example of an embodiment of as augmented reality presentation system that includes the capability to distribute comments to one or more augmented reality devices.

FIG. 5A is a functional block diagram that depicts an example of an embodiment of augmented reality presentation system 100, wherein presentation controller 105 receives comments from, and sends comments to, one or more augmented reality devices, in accordance with an embodiment of the present disclosure. In the embodiment depicted in FIG. 5A, presentation controller 105 has access to comment database 405. Comment database 405 is a data repository that stores data relating to viewer comments. Comment database 405 is analogous to annotations database 120 and viewer profile database 125 in terms of accessibility and the types of computer storage media on which data is stored. Table 410 is a table that depicts one example of a data structure of comment database 405. In table 410, each row is associated with a viewer comment. Table 410 includes columns that respectively associate with each comment a number, a viewer name, a key, an element of an audio-visual presentation (i.e., the context of the comment), content, and a location in which augmented reality devices are to present the content. In various embodiments, comment content includes text, images, video, and/or audio. Persons of ordinary skill in the art will understand that a variety of other data structures are possible. In the example depicted in FIG. 5A, the first and fourth rows of table 410 are respectively associated with comment 420 and comment 425. In this example, comments 420 and 425 are comments that presentation controller 105 received from the user of AR device 133 (i.e., Viewer 1, as shown in Table 410) over network 130. Comments 420 and 425 are associated with the HQ 1 key, as discussed with respect to FIGS. 1, 3A, and 3B. As shown in table 410, viewers of an audio-visual presentation (e.g., base presentation 115) are able to comment on various aspects of the base presentation (e.g., one or more slide of the presentation) or specific annotations in the example depicted in FIG. 5A.

In the embodiment depicted in FIG. 5A, AR presentation logic 200 generates a portion of the data within comment database 405/table 410. In table 410, for example, AR presentation logic 200 generates data that describes how one or more augmented reality devices are to present comments. In some embodiments, AR presentation logic 200 determines how augmented reality device(s) are to present comments based, at least in part, on how annotations are presented to the users of the augmented reality device(s). In FIGS. 5A and 5B, for example, comments 420 and 425 are respectively associated with annotations 305 and 335. Annotations 305 is presented as an overlay on base presentation 115 in FIG. 3B. Annotation 335 is presented in a supplemental information field in FIG. 3B. In the example depicted in FIG. 3B, supplemental information fields 340 and 345 do not include annotation content. Consequently, AR presentation logic 200 populates comment database 405 with data that instructs one or more augmented reality devices to respectively present comments 420 and 425 in supplemental information fields 340 and 345, as shown in FIG. 5B. In some embodiments, visual representations of comments are merged with visual representations of respective elements of an audiovisual presentation (e.g., a comment is presented as an overlay on an annotation that is the subject of the comment). In some embodiments viewers (e.g., Viewer 1 and/or Viewer 4) are able to select how comments are displayed on their respective AR devices (e.g., AR device 133 and 153). In one example of such embodiments, viewer profiles include data that describes preferences of respective viewers, such as whether or not a specific viewer wishes to receive comments and/or how the specific viewer wishes comments to be displayed. In another example of such embodiments, viewers select preferences on their respective AR devices.

In the embodiment depicted in FIG. 5A, AR presentation logic 200 causes presentation controller 105 to send comments to one or more augmented reality devices based, at least in part, on the context of the comments. Table 410, for example, shows that some comments comment on specific annotations, while other comments comment on elements of base presentation 115 (e.g., “Slide 1”). In some embodiments, some annotations are associated with one or more keys, as discussed herein with respect to FIGS. 1, 3A, and 3B. In some embodiments, comments that are made in reference to annotations that are associated with one or more keys are associated with the respective keys. Comments 420 and 425, for example, are associated with the HQ 1 key because they are respectively associated with annotations 305 and 335, which are associated with the HQ 1 key. Consequently, AR presentation logic 200 causes presentation controller 105 to send comments 420 and 425 to augmented reality devices that are associated with the HQ 1 key (e.g., AR device 133). In other words, augmented reality presentation system 100 must permit the viewer to view an annotation for a viewer to view a comment made in references to the annotation. As discussed in further detail with respect to FIG. 6, in some embodiments, AR presentation logic 200 searches viewer profile database 125 to identify viewers (and respective augmented reality devices) that are associated with one or more keys. Other annotations in table 410, however, are made in reference to “Slide 1” of base presentation 115. Comments that are associated with base content of an audio-visual presentation (e.g., base presentation 115), can be sent to augmented reality devices (or other computing devices) that are connected to presentation controller 105 over network 130, regardless of the key(s) that are associated with the device(s). AR devices 133 and 153, for example, are capable of receiving the comments described in the second and fifth rows of table 410, regardless of the keys that are associated with AR devices 133 and 153.

FIG. 5B is a functional block diagram that depicts an example of an augmented reality presentation as viewed on an augmented reality device, wherein the augmented reality device presents two of the annotations described in FIG. 3A and two of the comments described in FIG. 5A, in accordance with an embodiment of the present disclosure. In the example depicted in FIG. 5B, “Viewer 1” of tables 127 and 410 is the user of AR device 133. In this example, AR device 133 is a head-mounted augmented reality device (e.g., a pair of augmented reality eyeglasses), and display 137 is a transparent electronic display (e.g., a transparent OLED display). In FIG. 5B, display 107 presents “Slide 1” of base presentation 115. A portion of “Slide 1” is visible through inactive portion(s) of display 137, which presents visual representations of annotations 305 and 335 and comments 420 and 425, as discussed herein with respect to FIGS. 3A, 3B, 5A, and 5B.

FIG. 6 is a flowchart that depicts operations 450 of AR presentation logic 200 on presentation controller 105 within augmented reality comment system 400, in accordance with an embodiment of the present disclosure.

In operation 455, presentation controller 105 receives a comment from an augmented reality device over network 130 (e.g., AR device 133). As described herein with respect to FIG. 5A, a comment can include content in the form of text, images, video, and/or audio that is in reference to a specific annotation or one or more elements of base presentation content (e.g., base presentation 115). A comment can also include metadata that describes the comment content, including one or more keys, as depicted in table 410 and discussed with respect to FIG. 5A.

In operation 460, AR presentation logic 200, stores comment content and metadata in a database (e.g., comment database 405). As discussed with respect to FIG. 5A, in some embodiments, the comment is associated with one or more keys or no key based, at least in part, on the context of the comment. FIG. 6 depicts an embodiment where the comment is associated with a key. In some embodiments, AR presentation logic 200 generates data that is associated with the comment in operation 460. As discussed with respect to FIG. 5A, for example, the generated data can include data that describes how augmented reality devices (e.g., AR devices 133 and 153) are to present the comment content.

In operation 465, AR presentation logic 200 searches a viewer profile database (e.g., viewer profile database 125) for viewers that are associated with the key that is associated with the comment. AR presentation logic 200 identifies these viewers in operation 465. In operation 465, AR presentation logic 200 also identifies augmented reality devices that are associated with these viewers, as discussed with respect to FIG. 1. If the comment is not associated with a key because the comment is in reference to one or more elements of the base presentation content (e.g., base presentation 115), as discussed with respect to FIG. 5A, operation 465 is omitted. Operation 465 is also omitted in embodiments where keys are not associated with viewers and/or comments.

In operation 470, AR presentation logic 200 causes presentation controller 105 to send the comment to one or more augmented reality devices, in accordance with the result of operation 465. If the comment is not associated with a key because the comment is in reference to one or more elements of the base presentation content (e.g., base presentation 115), presentation controller 105 sends the comment to any augmented reality device (or another computing device) that is connected to presentation controller 105 over network 130. In embodiments where keys are not associated with viewers and/or comments, presentation controller 105 sends the comment to any augmented reality device (or another computing device) that is connected to presentation controller 105 over network 130.

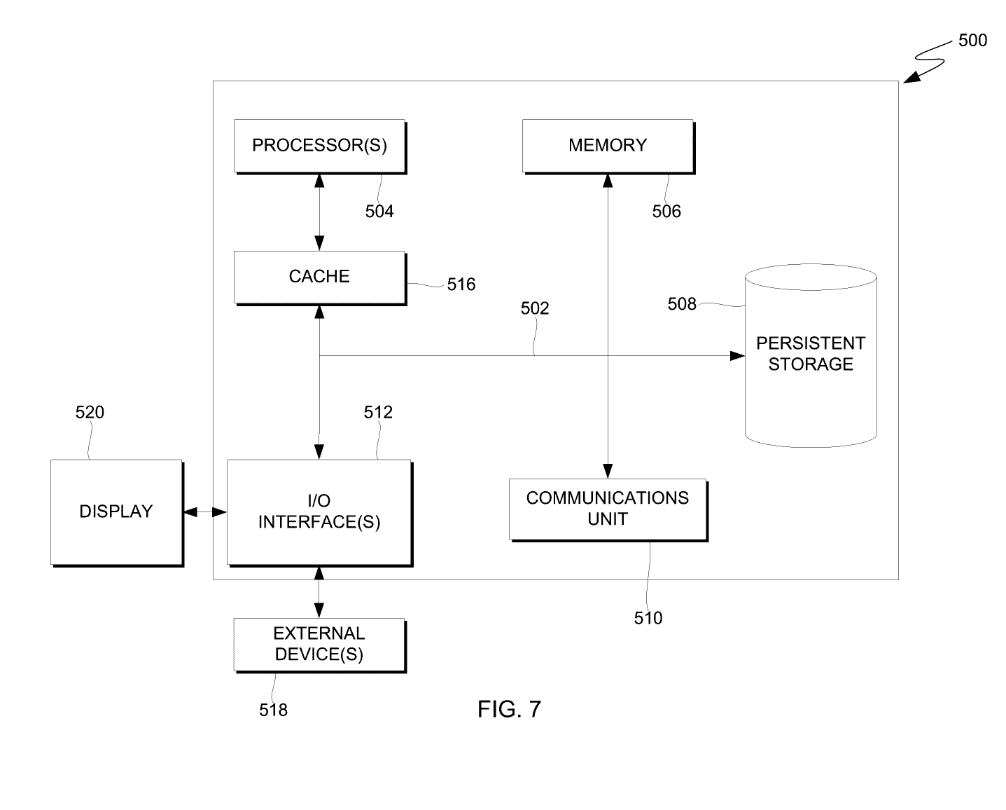

FIG. 7 depicts computer system 500. In some embodiments, computer system 500 is representative of presentation controller 105, AR device controller 135, and/or AR device controller 155. Computer system 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of processors 504 by holding recently accessed data and data near accessed data from memory 506.

Program instructions and data used to practice embodiments of the present invention may be stored in persistent storage 508 for execution by one or more of the respective processors 504 via cache 516 and one or more memories of memory 506. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to each computer system. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
registering, by one or more computer processors, an occurrence of a trigger event, wherein the trigger event is associated with an annotation of an audiovisual presentation; and
sending, by one or more computer processors, the annotation to an augmented reality device that is associated with a key, wherein the augmented reality device is associated with the key based, at least in part, on one or more attributes of a viewer profile that is associated with the augmented reality device.

2. The method of claim 1, further comprising:
associating, by one or more computer processors, the viewer profile with the augmented reality device based, at least in part, on having received, by one or more computer processors, the viewer profile from the augmented reality device; and
associating, by one or more computer processors, the key with the viewer profile.

3. The method of claim 1, further comprising:
sending, by one or more computer processors, metadata that describes the annotation to the augmented reality device, wherein the metadata includes an instruction to present the annotation as an overlay.

4. The method of claim 1, further comprising:
sending, by one or more computer processors, metadata that describes the annotation to the augmented reality device, wherein the metadata includes an instruction to present the annotation in a supplemental information field.

5. The method of claim 1, further comprising:
receiving, by one or more computer processors, an annotation request from the augmented reality device;
receiving, by one or more computer processors, gaze point data from the augmented reality device, wherein the gaze point data includes coordinates of a gaze point; and
wherein sending the annotation to the augmented reality device is performed in response to determining, by one or more computer processors, that a distance between the gaze point and a trigger point is less than a threshold distance, wherein the annotation is associated with the trigger point.

6. The method of claim 1, further comprising:
receiving, by one or more computer processors, data that describes a comment, wherein the data is received from the augmented reality device;
storing, by one or more computer processors, the data that describes the comment in a comment database; and
sending, by one or more computer processors, the comment to each of a plurality of augmented reality devices.

7. The method of claim 6, further comprising:
determining, by one or more computer processors, that the data that the comment is associated with is an annotation and, in response, identifying, by one or more computer processors, each of the plurality of augmented reality devices based, at least in part, on the key, wherein each of the plurality of augmented reality devices is associated with the key.

8. A computer program product, the computer program product comprising:
a computer readable storage medium and program instructions stored on the computer readable storage medium, the program instructions comprising:
program instructions to register an occurrence of a trigger event, wherein the trigger event is associated with an annotation of an audiovisual presentation; and
program instructions to send the annotation to an augmented reality device that is associated with a key, wherein the augmented reality device is associated with the key based, at least in part, on one or more attributes of a viewer profile that is associated with the augmented reality device.

9. The computer program product of claim 8, the program instructions further comprising:
program instructions to associate the viewer profile with the augmented reality device based, at least in part, on having received the viewer profile from the augmented reality device; and
program instructions to associate the key with the viewer profile.

10. The computer program product of claim 8, the program instructions further comprising:
program instructions to send metadata that describes the annotation to the augmented reality device, wherein the metadata includes an instruction to present the annotation as an overlay.

11. The computer program product of claim 8, the program instructions further comprising:
program instructions to send metadata that describes the annotation to the augmented reality device, wherein the metadata includes an instruction to present the annotation in a supplemental information field.

12. The computer program product of claim 8, the program instructions further comprising:
program instructions to receive an annotation request from the augmented reality device;
program instructions to receive gaze point data from the augmented reality device, wherein the gaze point data includes coordinates of a gaze point; and
program instructions to determine a distance between the gaze point and a trigger point, wherein the annotation is associated with the trigger point, and wherein the program instruction to send the annotation to the augmented reality device are performed in response to determining that the distance between the gaze point and the trigger point is less than a threshold distance.

13. The computer program product of claim 8, the program instructions further comprising:
program instructions to receive data that describes a comment, wherein the data is received from the augmented reality device;
program instructions to store data that describes the comment in a comment database; and
program instructions to send the comment to each of a plurality of augmented reality devices.

14. The computer program product of claim 13, the program instructions further comprising:
program instructions to, responsive to determining that the data that the comment is associated with is an annotation, identify each of the plurality of augmented reality devices based, at least in part, on the key, wherein each of the plurality of augmented reality devices is associated with the key.

15. A computer system, the computer system comprising:
one or more computer processors;
one or more computer readable storage media;
program instructions stored on the computer readable storage media for execution by at least one of the one or more computer processors, the program instructions comprising:
program instructions to register an occurrence of a trigger event, wherein the trigger event is associated with an annotation of an audiovisual presentation; and
program instructions to send the annotation to an augmented reality device that is associated with a key, wherein the augmented reality device is associated with the key based, at least in part, on one or more attributes of a viewer profile that is associated with the augmented reality device.

16. The computer system of claim 15, the program instructions further comprising:
program instructions to associate the viewer profile with the augmented reality device based, at least in part, on having received the viewer profile from the augmented reality device; and
program instructions to associate the key with the viewer profile.

17. The computer system of claim 15, the program instructions further comprising:
program instructions to send metadata that describes the annotation to the augmented reality device, wherein the metadata includes an instruction to present the annotation as an overlay.

18. The computer system of claim 15, the program instructions further comprising:
program instructions to receive an annotation request from the augmented reality device;
program instructions to receive gaze point data from the augmented reality device, wherein the gaze point data includes coordinates of a gaze point; and
program instructions to determine a distance between the gaze point and a trigger point, wherein the annotation is associated with the trigger point, and wherein the program instruction to send the annotation to the augmented reality device are performed in response to determining that the distance between the gaze point and the trigger point is less than a threshold distance.

19. The computer system of claim 15, the program instructions further comprising:
program instructions to receive data that describes a comment, wherein the data is received from the augmented reality device;
program instructions to store data that describes the comment in a comment database; and
program instructions to send the comment to each of a plurality of augmented reality devices.

20. The computer system of claim 19, the program instructions further comprising
program instructions to, responsive to determining that the data that the comment is associated with is an annotation, identify each of the plurality of augmented reality devices based, at least in part, on the key, wherein each of the plurality of augmented reality devices is associated with the key.
